(19) United States
(12) Patent Application Publication
(10) Pub. No.: US 2026/0296248 A1
(43) Pub. Date: Oct. 1, 2026

(54) CHARGING SCHEDULE PROPOSAL SYSTEM AND CHARGING SCHEDULE PROPOSAL DEVICE

(71) Applicant: HONDA MOTOR CO., LTD., Tokyo (JP)

(72) Inventors: Toru Kimura, Offenbach am Main (DE); Martin Kopp, Offenbach am Main (DE)

(21) Appl. No.: 19/541,428

(22) Filed: Feb. 17, 2026

(30) Foreign Application Priority Data
Mar. 28, 2025 (JP) 2025-055610

(51) Int. Cl. B60L 53/62; B60L 53/51; B60L 53/52; B60L 53/64

(52) U.S. Cl. CPC B60L 53/62; B60L 53/51; B60L 53/52; B60L 53/64; B60L 2240/66; B60L 2240/80; B60L 2250/12; B60L 2250/18; B60L 2260/46; B60L 2260/58

(57) ABSTRACT

A charging schedule proposal system includes: a charging device configured to charge a motor-driven vehicle with electric power; an information acquiring part configured to acquire charging environment information regarding a charging environment of the motor-driven vehicle and user schedule information regarding a user schedule; a schedule generating part configured to generate a charging schedule of the motor-driven vehicle using the charging device on the basis of the charging environment information and the user schedule information; and a proposal part configured to propose the charging schedule to a user. The schedule generating part prepares the charging schedule in a charging type which is one of a mobility priority type in which mobility of the motor-driven vehicle is prioritized and an energy priority type in which energy is prioritized.

### CROSS-REFERENCE TO RELATED APPLICATION

Priority is claimed on Japanese Patent Application No. 2025-055610, filed Mar. 28, 2025, the content of which is incorporated herein by reference.

### BACKGROUND OF THE INVENTION

### Field of the Invention

The present invention relates to a charging schedule proposal system and a charging schedule proposal device.

### Description of Related Art

In recent years, research and development on renewable energy contributing to enhancement in energy efficiency has been performed to secure access to sustainable and advanced energy on which more persons affordably rely. A charging schedule proposal system for efficiently using electric power energy has been disclosed (for example, see Japanese Unexamined Patent Application, First Publication No. 2024-70603).

The charging schedule proposal system determines a surplus time period indicating a time period in which electric power to be supplied is equal to or greater than a predetermined surplus of electric power and predicts a charging-required time indicating a time at which a state of a battery of a motor-driven vehicle satisfies a condition in which predetermined charging is required. The charging schedule proposal system proposes a power consumption state of a battery of a motor-driven vehicle or adjustment of the timing at which the battery of the motor-driven vehicle is charged such that charging of the battery is possible in the surplus time period on the basis of the predicted charging-required time.

### SUMMARY OF THE INVENTION

The charging schedule proposal system disclosed in Japanese Unexamined Patent Application, First Publication No. 2024-70603 proposes adjustment of the timing at which the battery of the motor-driven vehicle is charged or the like without considering a schedule in which a user of the motor-driven vehicle uses the motor-driven vehicle. Accordingly, for example, when a user is going to move to a destination in a hurry, a schedule in which the motor-driven vehicle stops by a charging facility and is charged or the like may be proposed, and thus the user may feel troubled. In recent years, since a selling price of renewable energy generated using a household solar panel has tended to decrease due to end of purchase of photovoltaic electric power, there is increasing need for charging a motor-driven vehicle with renewable energy generated in the household and consuming the energy in the motor-driven vehicle.

An aspect of the present invention provides a charging schedule proposal system and a charging schedule proposal device that can enhance energy efficiency according to individual situations of users. An aspect of the present invention contributes to enhance in energy efficiency.
(1) A charging schedule proposal system according to an aspect of the present invention is a charging schedule proposal system including: a power generation device; a charging device configured to charge a motor-driven vehicle with electric power generated by the power generation device and electric power supplied from a grid energy source; an information acquiring part configured to acquire charging environment information regarding a charging environment of the motor-driven vehicle and user schedule information regarding a user schedule; a schedule generating part configured to generate a charging schedule of the motor-driven vehicle using the charging device on the basis of the charging environment information and the user schedule information; and a proposal part configured to propose the charging schedule to a user, wherein the schedule generating part prepares the charging schedule in a charging type which is one of a mobility priority type in which mobility of the motor-driven vehicle is prioritized and an energy priority type in which energy is prioritized.
(2) In the charging schedule proposal system according to the aspect of (1), the schedule generating part may calculate an economic merit when a departure time of the motor-driven vehicle is delayed from a departure time in the user schedule when generating the charging schedule by the energy priority type, and the proposal part may present the economic merit when there is an economic merit and propose to delay the departure time of the motor-driven vehicle.
(3) In the charging schedule proposal system according to the aspect of (1), the schedule generating part may prepare the charging schedule additionally on the basis of whether the user schedule is a punctuality schedule which is a punctual schedule or a flexible schedule which is a schedule with a changeable time.
(4) In the charging schedule proposal system according to the aspect of (1), the schedule generating part may generate a charging schedule in which a departure time of the user is set to the same as in the user schedule when a state of charge of an in-vehicle power storage device provided in the motor-driven vehicle is high, the state of charge of the in-vehicle power storage device is middle, or the state of charge of the in-vehicle power storage device is low and the predicted weather based on weather forecast information is bad, and the schedule generating part may generate a charging schedule in which the departure time of the motor-driven vehicle is delayed from the departure time in the user schedule when the state of charge of the in-vehicle power storage device is low, the predicted weather based on the weather forecast information is good, and the user schedule is the flexible schedule.
(5) In the charging schedule proposal system according to the aspect of (4), when the state of charge of the in-vehicle power storage device is middle and the predicted weather based on the weather forecast information is bad, the schedule generating part may charge the in-vehicle power storage device with minimum electric power when the state of charge of the in-vehicle power storage device is able to secure necessary electric power at the time of execution of the user schedule, and the schedule generating part may propose with which of electric power of grid energy and electric power of a charging station in an outbound destination a shortage of the necessary electric power is to be filled when the state of charge of the in-vehicle power storage device is not able to secure the necessary electric power at the time of execution of the user schedule.
(6) In the charging schedule proposal system according to the aspect of (4), the schedule generating part may propose with which of electric power of grid energy and electric power of a charging station in an outbound destination a shortage of the necessary electric power is filled when the state of charge of the in-vehicle power storage device is low and the predicted weather based on the weather forecast information is bad.
(7) In the charging schedule proposal system according to the aspect of (1), the schedule generating part may re-generate the charging schedule when the charging type is the energy priority type and a state of charge of an in-vehicle power storage device provided in the motor-driven vehicle immediately before executing the user schedule is equal to or less than a threshold value.
(8) A charging schedule proposal device according to another aspect of the present invention is a charging schedule proposal device including: an information acquiring part configured to acquire charging environment information regarding a charging environment of a motor-driven vehicle and user schedule information regarding a user schedule; a schedule generating part configured to generate a charging schedule of the motor-driven vehicle using a charging device charging the motor-driven vehicle with electric power generated by a power generation device and electric power supplied from a grid energy source on the basis of the charging environment information and the user schedule information; and a proposal part configured to propose the charging schedule to a user, wherein the schedule generating part prepares the charging schedule in a charging type which is one of a mobility priority type in which mobility of the motor-driven vehicle is prioritized and an energy priority type in which energy is prioritized.

According to the aspects of (1) to (8), it is possible to enhance a user’s motivation of use of renewable energy.

### BRIEF DESCRIPTION OF THE DRAWINGS

FIG. 1 is a diagram illustrating an example of a configuration of a charging schedule proposal system according to an embodiment.

FIG. 2 is a table illustrating results of use in consideration of a schedule of a motor-driven vehicle.

FIG. 3 is a flowchart illustrating an example of a process flow that is performed by a charging schedule proposal device.

FIG. 4 is a flowchart illustrating an example of a process flow that is performed by the charging schedule proposal device.

### DETAILED DESCRIPTION OF THE INVENTION

Hereinafter, a charging schedule proposal system and a charging schedule proposal device according to an embodiment of the present invention will be described with reference to the accompanying drawings. In order to make constituents be recognizable, scales of the constituents are appropriately changed in the drawings used for the following description. In all the drawings for explaining the embodiment, elements having the same functions will be referred to by the same reference signs, and repeated description thereof will be omitted.

“On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information).

In the present embodiment, a schedule for charging a storage battery (an in-vehicle power storage device) of a motor-driven vehicle when the motor-driven vehicle is used according to a user schedule is proposed. The charging schedule proposal system generates a charging schedule on the basis of charging environment information regarding a charging environment of the motor-driven vehicle and user schedule information regarding the user schedule. The charging schedule proposal system performs charging in one of a mobility priority type in which mobility of the motor-driven vehicle is prioritized and an energy priority type in which energy is prioritized. In the following description, “electric power (an amount of electric power)” may refer to “energy (an amount of energy).”

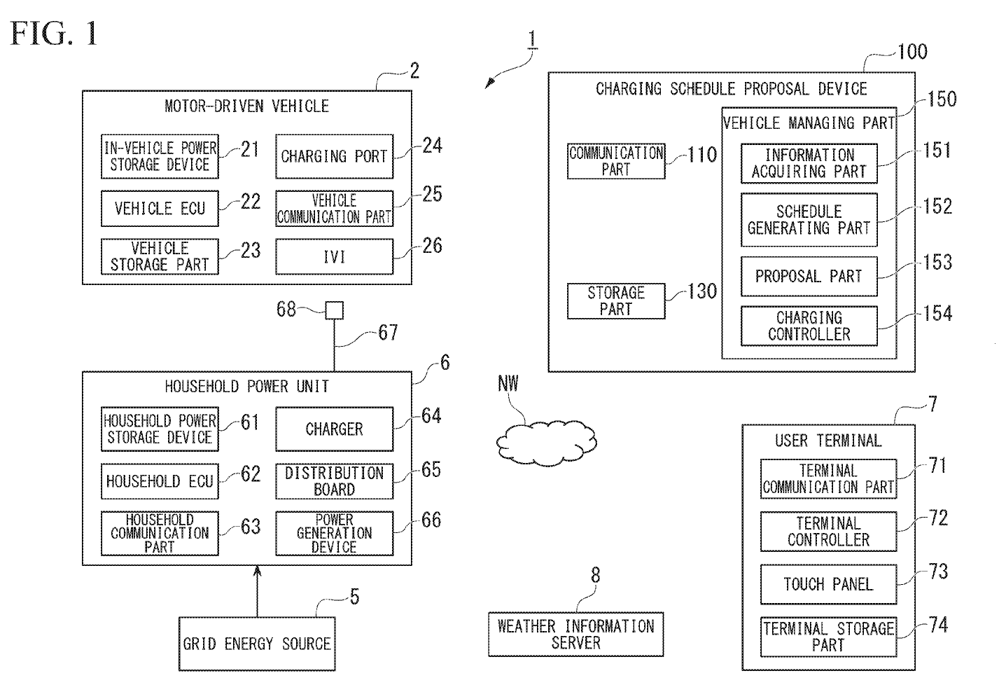

FIG. 1 is a diagram illustrating an example of a configuration of a charging schedule proposal system 1 according to the embodiment. The charging schedule proposal system 1 includes, for example, a motor-driven vehicle 2, a grid energy source 5, a household power unit 6, a user terminal 7, and a charging schedule proposal device 100. The charging schedule proposal device 100 may be provided, for example, in a management center performing charging management or a charging station outside of the motor-driven vehicle 2 or in the motor-driven vehicle 2.

The motor-driven vehicle 2, the grid energy source 5, the household power unit 6, the user terminal 7, a weather information server 8, and the charging schedule proposal device 100 are communicatively connected to each other via a network NW. The network NW is, for example, based on a wireless manner, but may be based on a wired manner for immobile elements.

When stored electric power is short, for example, the motor-driven vehicle 2 is charged by the household power unit 6 or charged with electric power supplied from a charging station (not illustrated) provided in an outbound destination or the like. Electric power used for charging is electric power derived from renewable energy (RE) or grid energy (GE).

The motor-driven vehicle 2 is an electric vehicle (EV) that travels with electricity as an energy source and with an electric motor (not illustrated) as a power source. The motor-driven vehicle 2 includes, for example, an in-vehicle power storage device 21, a vehicle ECU 22, a vehicle storage part 23, a charging port 24, a vehicle communication part 25, and an in-vehicle infotainment (hereinafter referred to as IVI) 26. The motor-driven vehicle 2 is, for example, an electric vehicle using electric power, but the motor-driven vehicle 2 may be a hybrid vehicle, a fuel-cell vehicle, an electric bike, or the like.

The in-vehicle power storage device 21 is a storage battery or a capacitor which is mounted in the motor-driven vehicle 2. The in-vehicle power storage device 21 stores electric power transmitted from a charging station or the household power unit 6 when the motor-driven vehicle 2 and the charging station or the household power unit 6 are electrically connected. Energy stored in the in-vehicle power storage device 21 may be renewable energy, grid energy, or both thereof.

Electric power stored in the in-vehicle power storage device 21 is supplied to the constituents (for example, an electric motor) of an electric system of the motor-driven vehicle 2. Identification information for identifying the in-vehicle power storage device 21 may be given to the in-vehicle power storage device 21. The in-vehicle power storage device 21 may include a plurality of cells, and identification information for identifying each cell may be given to the corresponding cell.

The vehicle ECU 22 is an electronic control unit. The vehicle ECU 22 controls storage of electric power in the in-vehicle power storage device 21 or controls supply of the stored electric power to the constituents of the electric system of the motor-driven vehicle 2. The vehicle ECU 22, the in-vehicle power storage device 21, the electric motor, and the vehicle communication part 25, and the like are connected to each other via a communication line such as a controller area network (CAN).

The vehicle ECU 22 calculates a distance (hereinafter referred to as a travel distance) by which a host vehicle has traveled on the basis of detection results from various sensors such as wheel speed sensors. The vehicle ECU 22 manages and monitors a charging state of charge (SOC) of electric power (energy) stored in the in-vehicle power storage device 21. The vehicle ECU 22 acquires a connection state between the charging port 24 and a household charging plug 68.

The vehicle ECU 22 stores the acquired travel distance in the vehicle storage part 23 and stores the charging SOC of energy and the connection state as vehicle information in the vehicle storage part 23. The vehicle ECU 22 transmits the acquired travel distance and the vehicle information to the charging schedule proposal device 100 using the vehicle communication part 25. The charging SOC is an example of an amount of charged electric power.

The vehicle ECU 22 may store electric power based on regenerative energy from the electric motor in the in-vehicle power storage device 21. When the in-vehicle power storage device 21 includes a plurality of cells, the vehicle ECU 22 may store a cell in which renewable energy is stored in the vehicle storage part 23 in correlation with identification information of the cell. The regenerative energy may be handled separately from renewable energy or grid energy.

The vehicle ECU 22 may calculate electric power of a load such as an air-conditioning device other than the electric motor and store the calculated electric power in the vehicle storage part 23 or transmit the calculated electric power to the charging schedule proposal device 100 using the vehicle communication part 25. When the load is an air-conditioning device provided in the motor-driven vehicle 2, the vehicle ECU 22 may calculate an amount of electric power consumed in the air-conditioning device on the basis of a time in which the air-conditioning device is used, a set temperature, or the like and store the calculated amount of electric power in the vehicle storage part 23.

The vehicle storage part 23 is, for example, a semiconductor memory device such as a flash memory, hard disk, or an optical disc. The vehicle storage part 23 stores information on an amount of energy acquired by the vehicle ECU 22, a travel distance calculated thereby, or a charging SOC of the in-vehicle power storage device 21. The travel distance or the charging SOC stored in the vehicle storage part 23 is transmitted to the charging schedule proposal device 100 by the vehicle communication part 25 according to necessity.

A charging plug 68 provided in the household power unit 6 can be connected to the charging port 24. By connecting the charging plug 68 to the charging port 24, the motor-driven vehicle 2 and the household power unit 6 are electrically connected via a cable 67. By electrically connecting the motor-driven vehicle 2 and a charging station or the household power unit 6, the motor-driven vehicle 2 can be charged with electric power from the household power unit 6.

The vehicle communication part 25 includes, for example, a communication interface such as a network interface card (NIC) card. The vehicle communication part 25 transmits and receives information to and from the charging schedule proposal device 100 or the like. For example, the vehicle communication part 25 transmits the travel distance acquired by the vehicle ECU 22 or stored in the vehicle storage part 23 or the charging SOC of the in-vehicle power storage device 21 to the charging schedule proposal device 100 via the network NW.

The IVI 26 is, for example, a system that provides information or entertainment to an occupant of the motor-driven vehicle 2. The IVI 26 includes, for example, a display. The IVI 26 provides information to a user who is an occupant by displaying an image including the information on the display. Information displayed on the IVI 26 includes, for example, information regarding a charging schedule for charging the motor-driven vehicle 2.

The grid energy source 5 is an energy source for supplying grid energy. The grid energy source 5 is mainly a power generation device from which CO2 exhaust at the time of power generation increases such as a thermal power generation device. The grid energy source 5 is managed, for example, by a power company, and grid energy is supplied from the grid energy source 5 to the household power unit 6, for example, under the management of the power company.

The household power unit 6 is provided, for example, a house (hereinafter referred to as a target house) such as the home of a user owning the motor-driven vehicle 2. The household power unit 6 includes, for example, a household power storage device 61, a household ECU 62, a household communication part 63, a charger 64, a distribution board 65, and a power generation device 66. A cable 67 and a charging plug 68 are connected to the charger 64.

The household power storage device 61 stores electric power. The household power storage device 61 is, for example, a storage battery or capacitor. The household power storage device 61 stores electric power generated by the power generation device 66 or electric power supplied from the grid energy source 5.

The household ECU 62 manages an amount of energy stored in the household power storage device 61, an amount of energy charged in the in-vehicle power storage device 21 of the motor-driven vehicle 2, and an amount of energy generated by the power generation device 66. The household ECU 62 transmits and provides information such as the managed amounts of energy to the charging schedule proposal device 100. The household ECU 62 may manage an amount of energy which is charged in household electric appliances in the target house or consumed in the household electric appliances or an amount of energy of electric power sold to a power company.

The household communication part 63 includes, for example, a communication interface such as an NIC card. The household communication part 63 transmits and receives information to and from the charging schedule proposal device 100 or the like. The household communication part 63 transmits, for example, information of energy provided by the household ECU 62 to the charging schedule proposal device 100.

The cable 67 is connected to the charger 64, and the charging plug 68 is connected to the cable 67. The charger 64 supplies energy stored in the household power storage device 61 to the motor-driven vehicle 2 via the cable 67 and the charging plug 68 under the control of the household ECU 62. The charger 64 is an example of a charging device.

The distribution board 65 distributes electric power generated by the power generation device 66 or supplied from the grid energy source 5 to the household power storage device 61 or the charger 64. The distribution board 65 may also serve as the household ECU 62. The distribution board 65 may distribute (sell) electric power generated by the power generation device 66 or stored in the in-vehicle power storage device 21 to household electric appliances or a power company.

The power generation device 66 is a power generation device that generates electric power which is renewable energy. The power generation device 66 is, for example, a solar panel. The power generation device 66 may be a wind power generation device or a geothermal power generation device. Electric power generated by the power generation device 66 is stored in the household power storage device 61 or supplied to the motor-driven vehicle 2 via the charger 64. Electric power generated by the power generation device 66 may be sold to a power company or the like.

The user terminal 7 is, for example, a terminal device that is owned by a user who owns the motor-driven vehicle 2. The user terminal 7 is, for example, a smartphone or a tablet. The user terminal 7 may be, for example, a personal computer provided in the household power unit 6 or the like. The user terminal 7 includes, for example, a terminal communication part 71, a terminal controller 72, a touch panel 73, and a terminal storage part 74.

The terminal communication part 71 includes, for example, a communication interface such as an NIC card. The terminal communication part 71 transmits and receives information to and from the charging schedule proposal device 100 or the like. The terminal communication part 71 receives, for example, information such as a charging schedule (a charging plan) transmitted from the charging schedule proposal device 100. The charging schedule is, for example, a schedule (a plan) associated with a charging time, an amount of charged electric power, or the like from before use of the motor-driven vehicle 2 and during use thereof. The terminal communication part 71 outputs information such as the acquired charging schedule to the terminal controller 72 or the like.

The terminal controller 72 acquires information transmitted from the charging schedule proposal device 100 and output from the terminal communication part 71. The terminal controller 72 acquires, for example, a charging schedule output from the terminal communication part 71. The terminal controller 72 displays various types of information including the acquired charging schedule on the touch panel 73. The terminal controller 72 acquires information corresponding to an input operation on the touch panel 73 and performs a process based on the acquired information.

The touch panel 73 has a function of an input device for receiving a user’s input operation and a function of a display device for displaying information provided by the terminal controller 72. The user terminal 7 may include an input device such as ten keys and an output device such as a display instead of the touch panel 73.

For example, the touch panel 73 visualizes and displays the charging schedule under the control of the terminal controller 72. A user determines whether to accept the charging schedule displayed on the touch panel 73 and requests re-generation of a charging schedule when the user determines not to accept the charging schedule. The touch panel 73 outputs input information corresponding to the user’s input operation to the terminal controller 72.

The terminal storage part 74 is, for example, a semiconductor memory device such as a flash memory, an SRAM, a DRAM, or a ROM. The terminal storage part 74 stores various types of information. For example, the terminal storage part 74 stores a user schedule generated by a calendar function or the like of the user terminal 7 as a schedule of a user who uses the motor-driven vehicle 2. The user schedule includes information such as a departure time at which the user departs from a departure place, for example, the home, and a destination. The terminal communication part 71 transmits the user schedule stored in the terminal storage part 74 to the charging schedule proposal device 100.

For example, the weather information server 8 collects information on various weather forecasts and generates information on the weather in each region. The information on the weather includes information on sunshine, for example, information such as a sunrise time, a sunset time, the weather (such as fine, cloudy, or rainy), and a temperature change. The weather information server 8 generates weather forecast information on the basis of the acquired information on the weather. The generated weather forecast information is transmitted to the charging schedule proposal device 100.

The charging schedule proposal device 100 is, for example, a server that is provided in a charging schedule proposal center. The charging schedule proposal device 100 generates a charging schedule of the motor-driven vehicle 2 on the basis of various types of information constituting the user schedule transmitted from the user terminal 7 and provides the charging schedule to the user via the touch panel 73 of the user terminal 7 or the IVI 26 of the motor-driven vehicle 2. At the time of generation of the charging schedule, the charging schedule proposal device 100 prepares a the charging schedule in one charging type of a mobility priority type in which mobility of the motor-driven vehicle 2 is prioritized and an energy priority type in which energy is prioritized.

The charging schedule proposal device 100 includes, for example, a communication part 110, a storage part 130, and a vehicle managing part 150. The vehicle managing part 150 includes, for example, an information acquiring part 151, a schedule generating part 152, a proposal part 153, and a charging controller 154. An acquisition part 120 and the vehicle managing part 150 are realized, for example, by causing a hardware processor such as a central processing unit (CPU) to execute a program (software). Some or all of these constituents may be realized by hardware (a circuit unit; including circuitry) such as a large scale integration (LSI) circuit, an application-specific integrated circuit (ASIC), a field-programmable integrated circuit (FPGA), or a graphics processing unit (GPU) or may be cooperatively realized by software and hardware.

The program may be stored in advance in the storage part 130 (a storage device including a non-transitory storage medium) such as an HDD or a flash memory or may be stored in a removable storage medium (a non-transitory storage medium) such as a DVD or a CD-ROM and installed by setting the storage medium into a drive device.

The communication part 110 includes, for example, a communication interface such as an NIC card. The communication part 110 transmits and receives information to and from the motor-driven vehicle 2, the household power unit 6, the user terminal 7, and the weather information server 8. For example, the communication part 110 receives the vehicle information transmitted from the vehicle communication part 25, the user schedule and the charging environment information transmitted from the household communication part 63, and the weather forecast information transmitted from the weather information server 8 and outputs the received information to the vehicle managing part 150.

The storage part 130 may be a semiconductor memory device such as a flash memory, a hard disk, an optical disc, or the like. The storage part 130 may be a drive device or the like which is externally attached. The storage part 130 stores various types of information on electric power with which the motor-driven vehicle 2 is charged in addition to the program. The storage part 130 stores, for example, user information which is registered when a user starts use of management of the charging schedule.

The user information includes information for identifying a user and charging environment information regarding a charging environment used by the user. The charging environment information includes, for example, information such as a charger, the in-vehicle power storage device 21, a type of the power generation device 66 (a solar panel), installation places of the charger 64 (charger) and the power generation device 66, and residence information of a residence in which the household power unit 6 is provided.

The information on a charger includes, for example, information of a charging capacity (kW) of the charger. The information on the in-vehicle power storage device 21 includes, for example, information of a charging capacity (kW) of the in-vehicle power storage device 21. The information on the power generation device 66 includes, for example, information a power generation capacity (kW) of the power generation device 66. The information on the installation place includes, for example, information such as an address, an installation position, and an installation angle of the power generation device 66. The residence information includes, for example, information on power consumption in a target house.

The information acquiring part 151 acquires charging environment information regarding the charging environment of the motor-driven vehicle 2 and user schedule information regarding the user schedule. The charging environment information is, for example, information on an environment in which the in-vehicle power storage device 21 of the motor-driven vehicle 2 is charged with energy. The information acquiring part 151 acquires the charging environment information and the user schedule information transmitted from the user terminal 7 and stored in the storage part 130. The information acquiring part 151 acquires, for example, vehicle information and weather forecast information output from the communication part 110.

The schedule generating part 152 generates a charging schedule on the basis of the vehicle information, the weather forecast information, the user schedule information, and the charging environment information acquired by the information acquiring part 151. The schedule generating part 152 determines the charging type as one of the mobility priority type and the energy priority type, for example, on the basis of the user schedule information and the charging environment information in generating the charging schedule. The schedule generating part 152 generates the charging schedule in the determined type. The charging type may be provided by the charging schedule proposal device 100 (the schedule generating part 152), for example, on the basis of an input operation performed on the user terminal 7 or another terminal device by the user.

The mobility priority type is a type in which mobility of the motor-driven vehicle 2 has priority to charging with energy, and the energy priority type is a type in which charging with energy has priority to the mobility of the motor-driven vehicle 2. The schedule generating part 152 causes the proposal part 153 to propose the generated schedule when the charging type is the mobility priority type and enables re-generation of the schedule such that a state of charge of the in-vehicle power storage device 21 before the motor-driven vehicle 2 moves is increased when the charging type is the energy priority type.

For example, in a basic idea, the schedule generating part 152 sets the charging type to the energy priority type when the weather in a place in which electric power for charging the motor-driven vehicle 2 is generated, for example, the installation place of a solar panel, is good and power generation efficiency is high. On the other hand, when the charging SOC of the motor-driven vehicle 2 is high and an amount of electric power to be used for charging is small, the schedule generating part 152 sets the charging type to the mobility priority type.

The proposal part 153 proposes the charging schedule generated by the schedule generating part 152 to the user. The proposal part 153 transmits the charging schedule generated by the schedule generating part 152 to the user terminal 7. The user terminal 7 displays and visualizes the transmitted charging schedule on the touch panel 73 under the control of the terminal controller 72. The user receives the proposed charging schedule by seeing the visualized charging schedule.

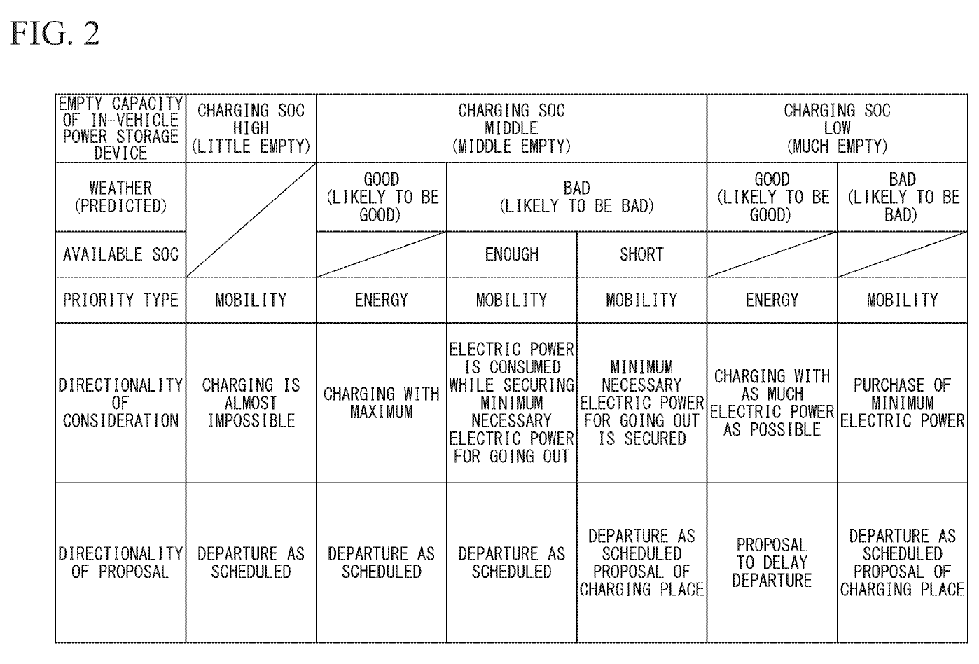

FIG. 2 is a table illustrating results of use in consideration of a schedule of the motor-driven vehicle 2. Here, consideration directionality and proposal directionality based on the charging SOC (an empty capacity) of the in-vehicle power storage device 21 and the predicted weather indicated by the weather forecast information are illustrated. The weather (predicted) is based on the weather forecast at the installation position of the power generation device 66. The consideration directionality is, for example, to what extent the in-vehicle power storage device 21 is to be charged and a supply source of energy at the time of charging. The proposal directionality is, for example, a proposal of a departure time of the motor-driven vehicle or whether charging is necessary after departure.

For example, when the charging SOC of the in-vehicle power storage device 21 is high and the empty capacity is very small, the charging type is set to the mobility priority type regardless of the weather (predicted) based on the weather forecast information. In this case, since charging of the in-vehicle power storage device 21 is almost impossible, charging is determined to be impossible. Since the charging type is set to the mobility priority type, the proposal part 153 proposes the departure time as scheduled in the user schedule.

When both the charging SOC and the empty capacity of the in-vehicle power storage device 21 are middle and the weather (predicted) based on the weather forecast information is good (is likely to be good), the schedule generating part 152 sets the charging type to the energy priority type. In this case, since the charging efficiency using the power generation device 66 is high, the in-vehicle power storage device 21 is maximally charged, and the proposal part 153 proposes the departure time as scheduled in the user schedule. When the in-vehicle power storage device 21 is fully charged and energy generated by the power generation device 66 becomes surplus, the surplus energy may be stored in the household power storage device 61 or may be sold as grid energy.

When both the charging SOC and the empty capacity of the in-vehicle power storage device 21 are middle and the weather (predicted) based on the weather forecast information is bad (is likely to be bad), the schedule generating part 152 sets the charging type to the mobility priority type. In this case, the directionality varies according to whether the charging SOC of the in-vehicle power storage device 21 is sufficient for an available SOC which can be used when the user schedule is executed.

When the charging SOC of the in-vehicle power storage device 21 is sufficient for the available SOC, a proposal of using power consumption of the in-vehicle power storage device 21 while securing electric power (hereinafter referred to as necessary electric power) necessary for executing the user schedule is given. The proposal part 153 proposes the departure time as scheduled in the user schedule.

When the charging SOC of the in-vehicle power storage device 21 is not sufficient (insufficient) for the available SOC, the schedule generating part 152 secures necessary electric power for executing the user schedule. The proposal part 153 proposes the departure time as scheduled in the user schedule and also proposes a charging place such as a charging station in an outbound destination when there is the charging place such as a charging station in the outbound destination.

When the charging SOC of the in-vehicle power storage device 21 is low, the empty capacity is large, and the weather (predicted) based on the weather information is good (is likely to be good), the schedule generating part 152 sets the charging type to the energy priority type. In this case, since the charging efficiency using the power generation device 66 is high, the in-vehicle power storage device 21 is maximally charged.

In this case, the schedule generating part 152 classifies schedules included in the user schedule into a punctuality schedule and a flexible schedule. The punctuality schedule is a punctual schedule and is, for example, a schedule which cannot be changed or a schedule which it is difficult to change such as a start time of a conference or a reserved time for a restaurant. The flexible schedule is a schedule with a changeable time and is, for example, a schedule in which it is relatively easy to change such as a shopping time or a taste in a free time.

For example, when the charging SOC is low and the weather (predicted) based on the weather information is good, economic advantages are often achieved by delaying the departure time by a predetermined time and charging the in-vehicle power storage device 21 with electric power stored in the household power storage device 61 in comparison with a case in which the in-vehicle power storage device 21 is charged in a charging station in an outbound destination or the like. Accordingly, when the user schedule includes only a punctuality schedule but does not include a flexible schedule and, the proposal part 153 proposes the departure time as scheduled in the user schedule. On the other hand, when the user schedule includes a flexible schedule, the proposal part 153 proposes a departure time delayed from the departure time scheduled in the user schedule.

The schedule generating part 152 compares an economic load when the departure time is delayed and the in-vehicle power storage device 21 is charged with electric power generated by the power generation device 66 with an economic load when the in-vehicle power storage device 21 is charged in a charging place in an outbound destination and calculates an economic merit. When a departure time delayed from the departure time indicated by the user schedule is proposed, the proposal part 153 presents the economic merit calculated by the schedule generating part 152 together to the user.

For example, when the charging SOC is low and the weather (predicted) based on the weather information is bad (is likely to be bad), the schedule generating part 152 sets the charging type to the mobility priority type and purchases minimum electric power for executing the user schedule from grid energy. The proposal part 153 proposes the departure time as scheduled in the user schedule and also proposes a charging place such as a charging station in an outbound destination when there is the charging place such as a charging station in the outbound destination.

The charging controller 154 causes the vehicle ECU 22 and the household ECU 62 to perform charging control for charging the in-vehicle power storage device 21 of the motor-driven vehicle 2 using the household power unit 6. For example, it is assumed that the user connects the distribution board 65 of the household power unit 6 and the in-vehicle power storage device 21 of the motor-driven vehicle 2 using the cable 67 and the charging plug 68.

In this state, the vehicle ECU 22 and the household ECU 62 charges the in-vehicle power storage device 21 of the motor-driven vehicle 2 using the household power unit 6 on the basis of charging control information transmitted from the charging controller 154 in the charging schedule proposal device 100. When a charging operation of the in-vehicle power storage device 21 ends, the vehicle ECU 22 or the household ECU 62 transmits charging operation end information to the charging schedule proposal device 100. When the charging operation end information is received, the schedule generating part 152 in the charging schedule proposal device 100 generates charging completion information and notifies the user of the charging completion information by transmitting the charging completion information to the user terminal 7 or the like.

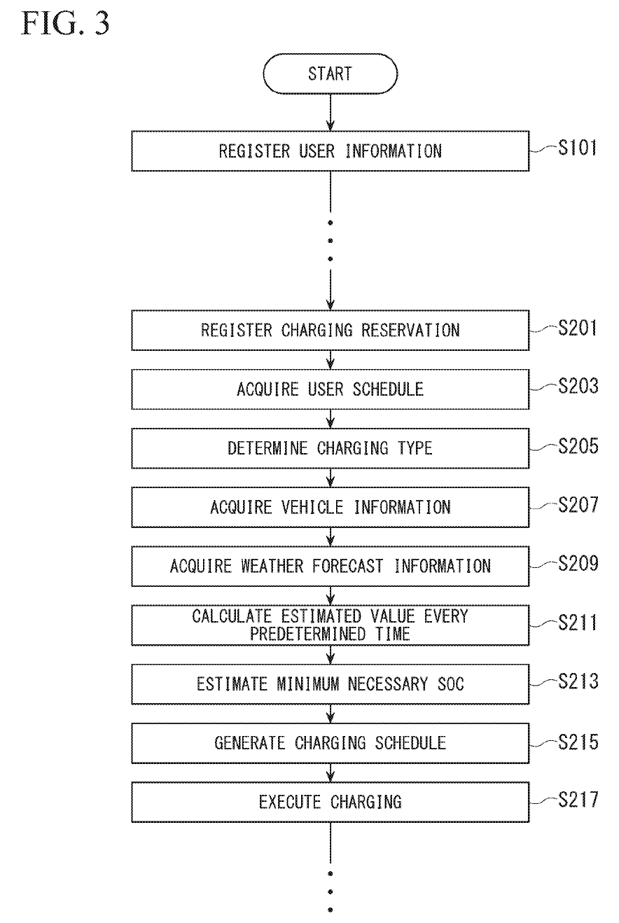

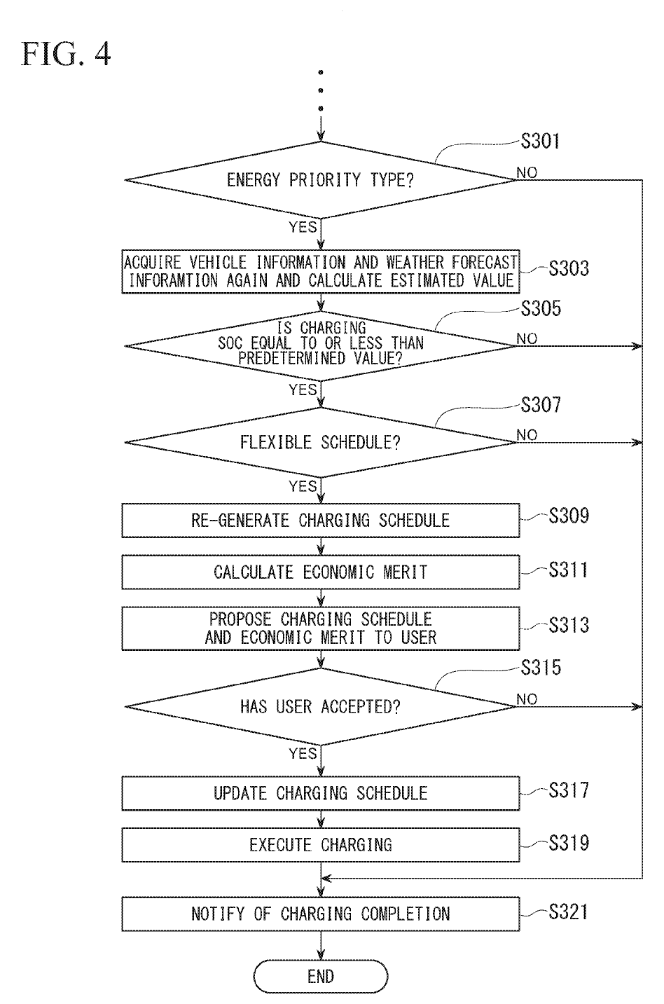

A process flow that is performed by the charging schedule proposal system 1 will be described below. FIGS. 3 and 4 are a flowchart illustrating an example of a process flow that is performed by the charging schedule proposal system 1. The charging schedule proposal system 1 generates a charging schedule, for example, on the basis of a user schedule of a user having been registered for use of the charging schedule proposal system 1 and proposes the charging schedule.

For example, the charging schedule proposal system 1 registers user information of a user who uses the charging schedule proposal system 1 in advance. In principle, the charging schedule proposal system 1 proposes charging schedules which will be executed on a day and immediately, for example, in 30 minutes, before the user schedule is performed. In the following description, a preprocess, a process on a previous day, and an immediately previous process will be described.

A preprocess will be first described. The charging schedule proposal device 100 in the charging schedule proposal system 1 receives and registers user information (Step S101). The user information is provided to the charging schedule proposal device 100, for example, on the basis of an input operation performed on the user terminal 7 or another terminal device by a user. The charging schedule proposal device 100 registers the provided user information and stores the provided user information in the storage part 130.

The process on the previous day will be then described. In the process on the previous day, the charging schedule proposal device 100 in the charging schedule proposal system 1 receives and registers a charging reservation (Step S201). The charging reservation is provided to the charging schedule proposal device 100, for example, on the basis of an input operation performed on the user terminal 7 or another terminal device by a user. For example, the information acquiring part 151 may periodically read and acquire a user schedule from the storage part 130 and actively acquire the charging reservation on the basis of the acquired user schedule.

When the charging reservation has been registered, the information acquiring part 151 of the charging schedule proposal device 100 reads and acquires a user schedule from the storage part 130 (Step S203). When the user schedule has been acquired, the information acquiring part 151 skips this process. Subsequently, the information acquiring part 151 acquires information on movement (hereinafter referred to as movement information) such as a departure time or a destination on the basis of the acquired user schedule. Subsequently, the schedule generating part 152 determines a charging type as one of the mobility priority type and the energy priority type (Step S205).

Subsequently, the information acquiring part 151 acquires vehicle information transmitted from the vehicle communication part 25 of the motor-driven vehicle 2 (Step S207). Subsequently, the information acquiring part 151 acquires weather forecast information transmitted from the weather information server 8 (Step S209). Here, the information acquiring part 151 acquires the weather forecast information until the departure time.

Subsequently, the schedule generating part 152 calculates an estimated value of necessary electric power to generate a charging schedule (Step S211). The schedule generating part 152 calculates, for example, output electric power (generated electric power) of the power generation device 66 every predetermined time of the user schedule, power consumption in a target house, and surplus electric power of the power generation device 66 (output electric power of the power generation device 66 – power consumption in the target house) as the estimated value. The surplus electric power is stored, for example, in the household power storage device 61.

Subsequently, the schedule generating part 152 calculates and estimates an SOC of the in-vehicle power storage device 21 which is a necessary minimum (hereinafter referred to as a necessary minimum SOC) for the vehicle to arrive at a destination as the necessary electric power on the basis of the vehicle information and the movement information acquired by the information acquiring part 151 (Step S213). For example, the necessary minimum SOC may be prepared by the user terminal 7 according to the user’s input operation and provided to the charging schedule proposal device 100.

Subsequently, the schedule generating part 152 generates a charging schedule on the basis of the determined charging type, the estimated necessary minimum SOC, the acquired departure time, and the charging environment information (Step S215). Subsequently, the charging schedule proposal system 1 charges the in-vehicle power storage device 21 of the motor-driven vehicle 2 according to the charging schedule generated by the charging schedule proposal device 100 (Step S217).

Charging of the in-vehicle power storage device 21 is performed according to an instruction from the vehicle ECU 22 or the household ECU 62 under the control of the charging schedule proposal device 100, for example, in a state in which the distribution board 65 and the in-vehicle power storage device 21 are connected via the cable 67 and the charging plug 68. Charging of the in-vehicle power storage device 21 may be performed according to a user’s manual operation.

The immediately previous process will be described below. When the charging type is the energy priority type, accuracy of the SOC of the in-vehicle power storage device 21 is enhanced by re-considering the charging schedule immediately before departure. FIG. 4 illustrates a process flow that is performed immediately before the departure time in the charging schedule proposal system 1.

Immediately before the departure time, the schedule generating part 152 of the charging schedule proposal device 100 determines whether the charging type is the energy priority type (Step S301). When it is determined that the charging type is the energy priority type, the schedule generating part 152 re-acquires vehicle information and weather forecast information and calculates an estimated value very predetermined time through the same process as in Step S211 (Step S303). The weather forecast information at that time ranges, for example, to 1 hour after the departure time.

Subsequently, the schedule generating part 152 determines whether the charging SOC of the in-vehicle power storage device 21 is equal to or less than a predetermined value (equal to or less than a threshold value) (Step S305). The predetermined value may be any value, for example, the necessary minimum SOC or a value determined on the basis of the necessary minimum SOC. When it is determined that the charging SOC of the in-vehicle power storage device 21 is equal to or less than the predetermined value, the schedule generating part 152 determines whether the user schedule is a flexible schedule (Step S307). The predetermined value is an example of a threshold value.

When the user schedule is a flexible schedule, the schedule can be often changed to delay departure. When it is determined that the user schedule is a flexible schedule, the schedule generating part 152 re-generates a charging schedule in which the departure time is delayed and charging of the in-vehicle power storage device 21 is continued during the delayed time (Step S309).

The schedule generating part 152 re-calculates, for example, a charging schedule in which the departure time is delayed and charging is performed using only surplus electric power stored in the household power storage device 61 during the delayed time. The electric power used for charging may include electric power based on grid energy in addition to the surplus electric power. Subsequently, the schedule generating part 152 calculates an economic merit (Step S311).

Subsequently, the proposal part 153 transmits the charging schedule with the delayed departure time to the user terminal 7 and proposes the charging schedule to the user (Step S313). The proposal part 153 presents the economic merit calculated by the schedule generating part 152 in addition to the charging schedule with the delayed departure time (Step S313).

The user to which the economic merit has been presented compares the economic merit, for example, with a demerit of schedule change and determines whether to accept the re-generated charging schedule. The user performs an input operation on the user terminal 7 and causes the user terminal 7 to transmit acceptance information indicating acceptance of change of the charging schedule or rejection information indicating rejection thereof. The schedule generating part 152 receives the acceptance information or the rejection information and determines whether the user is to accept the change of the charging schedule (Step S315).

When it is determined that the acceptance information has been acquired and the user has accepted the change of the charging schedule, the schedule generating part 152 updates the charging schedule (Step S317). Subsequently, the charging schedule proposal system 1 continues to charge the in-vehicle power storage device 21 of the motor-driven vehicle 2 according to the charging schedule re-generated by the charging schedule proposal device 100 (Step S319).

Thereafter, when a charging end time has come, the schedule generating part 152 in the charging schedule proposal system 1 generates and transmits charging completion information to the user terminal 7 to present the information to the user (Step S321). When it is determined in Step S301 that the charging type is not the energy priority type (is the mobility priority type), it is determined in Step S305 that the charging SOC of the in-vehicle power storage device 21 is equal to or less than the predetermined value, it is determined in Step S307 that the user schedule is not a flexible schedule, and it is determined in Step S315 that the acceptance information has not been acquired and the user has not accepted the change of the charging schedule, the schedule generating part 152 also generates and transmits charging completion information to the user terminal 7 to present the information to the user (Step S321). In this way, the charging schedule proposal system 1 ends the process flows illustrated in FIGS. 3 and 4.

In the charging schedule proposal system 1 according to the embodiment, the schedule generating part 152 of the charging schedule proposal device 100 generates a charging schedule of a motor-driven vehicle 2 on the basis of charging environment information and user schedule information. The schedule generating part 152 prepares the charging schedule in one charging type of a mobility priority type in which mobility of a motor-driven vehicle is prioritized and an energy priority type in which energy is prioritized in generating the charging schedule. Accordingly, since the charging schedule can be prepared with priority given to mobility or energy according to a user’s situation, it is possible to enhance energy use efficiency according to the individual user’s situation.

In the embodiment, the schedule generating part 152 may calculate a shortage of necessary electric power at the time of execution of the user schedule when a state of charge of the in-vehicle power storage device 21 is low and the predicted weather based on the weather forecast information is bad. The proposal part 153 may propose charging with one of electric power of grid energy and electric power of a charging station in an outbound destination as the shortage of the necessary electric power calculated by the schedule generating part 152. The electric power of the grid energy may be electric power of grid energy supplied from the grid energy source 5 in the household power unit 6.

In the embodiment, after the charging schedule has been generated, it is determined whether the user schedule is a flexible schedule and it is determined whether to re-generate the charging schedule, but it may be determined whether the user schedule is a flexible schedule before the charging schedule has been generated and the charging schedule may be generated on the basis of the determination result. In this case, both a charging schedule with a maintained departure time and a charging schedule with a delayed departure time may be generated and proposed and may be caused to be selected by the user. For example, when the user schedule is a flexible schedule, the energy priority type may be selected to generate a charging schedule.

A program may be transmitted from a computer system storing the program in a storage device or the like to another computer system via a transmission medium or using carrier waves in the transmission medium. Here, the “transmission medium” for transmitting a program is a medium having an information transmitting function like a network (a communication network) such as the Internet or a communication circuit line (a communication line) such as a telephone line. The program may be a program for realizing some of the aforementioned functions. The program may be a program for realizing the aforementioned functions in combination with another program stored in advance in the computer system, that is, a so-called differential file (a differential program).

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A charging schedule proposal system comprising:
a power generation device;
a charging device configured to charge a motor-driven vehicle with electric power generated by the power generation device and electric power supplied from a grid energy source;
an information acquiring part configured to acquire charging environment information regarding a charging environment of the motor-driven vehicle and user schedule information regarding a user schedule;
a schedule generating part configured to generate a charging schedule of the motor-driven vehicle using the charging device on the basis of the charging environment information and the user schedule information; and
a proposal part configured to propose the charging schedule to a user,
wherein the schedule generating part prepares the charging schedule in a charging type which is one of a mobility priority type in which mobility of the motor-driven vehicle is prioritized and an energy priority type in which energy is prioritized.

2. The charging schedule proposal system according to claim 1, wherein the schedule generating part calculates an economic merit when a departure time of the motor-driven vehicle is delayed from a departure time in the user schedule when generating the charging schedule by the energy priority type, and
wherein the proposal part presents the economic merit when there is an economic merit and proposes to delay the departure time of the motor-driven vehicle.

3. The charging schedule proposal system according to claim 1, wherein the schedule generating part prepares the charging schedule additionally on the basis of whether the user schedule is a punctuality schedule which is a punctual schedule or a flexible schedule which is a schedule with a changeable time.

4. The charging schedule proposal system according to claim 3, wherein the schedule generating part generates a charging schedule in which a departure time of the user is set to the same as in the user schedule when a state of charge of an in-vehicle power storage device provided in the motor-driven vehicle is high, the state of charge of the in-vehicle power storage device is middle, or the state of charge of the in-vehicle power storage device is low and the predicted weather based on weather forecast information is bad, and
wherein the schedule generating part generates a charging schedule in which the departure time of the motor-driven vehicle is delayed from the departure time in the user schedule when the state of charge of the in-vehicle power storage device is low, the predicted weather based on the weather forecast information is good, and the user schedule is the flexible schedule.

5. The charging schedule proposal system according to claim 4, wherein, when the state of charge of the in-vehicle power storage device is middle and the predicted weather based on the weather forecast information is bad, the schedule generating part charges the in-vehicle power storage device with minimum electric power when the state of charge of the in-vehicle power storage device is able to secure necessary electric power at the time of execution of the user schedule, and
the schedule generating part proposes with which of electric power of grid energy and electric power of a charging station in an outbound destination a shortage of the necessary electric power is filled when the state of charge of the in-vehicle power storage device is not able to secure the necessary electric power at the time of execution of the user schedule.

6. The charging schedule proposal system according to claim 4, wherein the schedule generating part proposes with which of electric power of grid energy and electric power of a charging station in an outbound destination a shortage of the necessary electric power at the time of execution of the user schedule is filled when the state of charge of the in-vehicle power storage device is low and the predicted weather based on the weather forecast information is bad.

7. The charging schedule proposal system according to claim 1, wherein the schedule generating part re-generates the charging schedule when the charging type is the energy priority type and a state of charge of an in-vehicle power storage device provided in the motor-driven vehicle immediately before executing the user schedule is equal to or less than a threshold value.

8. A charging schedule proposal device comprising:
an information acquiring part configured to acquire charging environment information regarding a charging environment of a motor-driven vehicle and user schedule information regarding a user schedule;
a schedule generating part configured to generate a charging schedule of the motor-driven vehicle using a charging device charging the motor-driven vehicle with electric power generated by a power generation device and electric power supplied from a grid energy source on the basis of the charging environment information and the user schedule information; and
a proposal part configured to propose the charging schedule to a user,
wherein the schedule generating part prepares the charging schedule in a charging type which is one of a mobility priority type in which mobility of the motor-driven vehicle is prioritized and an energy priority type in which energy is prioritized.
